(19) United States
(12) Patent Application Publication
(10) Pub. No.: US 2021/0341826 A1
(43) Pub. Date: Nov. 4, 2021

(54) PROJECTION APPARATUS

(71) Applicant: IVIEW DISPLAYS (SHENZHEN) COMPANY LTD., Shenzhen (CN)

(72) Inventors: Qiongsheng Xu, Shenzhen (CN); Zhiqiang Gao, Shenzhen (CN); Steve Yeung, Shenzhen (CN); Xiaofeng Pu, Shenzhen (CN)

(21) Appl. No.: 17/359,596

(22) Filed: Jun. 27, 2021

Related U.S. Application Data
(63) Continuation of application No. PCT/CN2019/129515, filed on Dec. 28, 2019.

(30) Foreign Application Priority Data
Dec. 29, 2018 (CN) 201822272320.9

(51) Int. Cl. G03B 21/28; G02B 7/182

(52) U.S. Cl. CPC G03B 21/28; G02B 7/1821

(57) ABSTRACT

The projection apparatus includes: a projection unit, a support frame, a mirror assembly, a mirror balance assembly, and an adjustment device. The projection unit is configured to emit a projection light beam. The mirror assembly is configured to reflect the projection light beam emitted by the projection unit. One end of the support frame is fixed to the projection unit, and the other end of the support frame is suspended. The mirror balance assembly is configured to suspend the mirror assembly to the other end of the support frame that is suspended. The mirror assembly is rotatable about at least one axis of rotation relative to the support frame. The adjustment device is configured to cause the mirror assembly to be inclined along the at least one axis of rotation relative to the mirror balance assembly. In this way, the mirror assembly is flexibly adjusted at a plurality of angles.

This application is based upon and claims priority to Chinese Patent Application No. 201822272320.9, filed before China National Intellectual Property Administration on Dec. 29, 2018 and entitled “PROJECTION APPARATUS,” the entire contents of which are incorporated herein by reference.

### TECHNICAL FIELD

The present disclosure relates to the technical field of optical projection, and in particular, relates to a projection apparatus.

### BACKGROUND

In recent years, with the development of semiconductor technologies, portable electronic products are becoming more and more diversified, and functionality of the electronic products are becoming more and more abundant and powerful. Under such circumstance, users are imposing more and more demands for large-screen projection, and thus developments of protection apparatuses are promoted.

A conventional reflective projection apparatus reflects a light beam by a mirror so as to change a projection direction. However, a reflection angle fails to be flexibly adjusted, and thus the protection apparatus features a small adjustment range.

### SUMMARY

To solve the above technical problem, embodiments of the present disclosure provide a projection apparatus capable of implementing multi-directional adjustment.

To solve the above technical problem, embodiments of the present disclosure provide a projection apparatus. The projection apparatus includes:

a projection unit, configured to emit a projection light beam;

a mirror assembly, suspended and configured to reflect the projection light beam emitted by the projection unit;

a support frame, one end of which is mounted on the projection unit;

a mirror balance assembly, configured to suspend the mirror assembly on the support frame, the mirror assembly being rotatable about at least one first axis of rotation relative to the support frame, the at least one first axis of rotation being disposed to define an included angle with the projection light beam emitted by the projection unit; and

an adjustment device, configured to drive the mirror assembly to rotate about the at least one first axis of rotation relative to the mirror balance assembly.

Optionally, the support frame includes a support base and a fixing block, one end of the support base being fixed to the projection unit, and the other end of the support base being provided with the fixing block; and

the mirror balance assembly is configured to suspend the mirror assembly on the fixing block, and the adjustment device is mounted on the fixing block.

Optionally, the mirror assembly includes a mirror and a mirror cover; wherein

the mirror is disposed on one side of the mirror cover, and the other side, facing away from the mirror, of the mirror cover is connected to the mirror balance assembly; and

the mirror is configured to reflect the projection light beam emitted by the projection unit.

Optionally, the adjustment device comprises a first adjustment unit, the first adjustment unit comprising a first steering engine, a first steering disc, and a first linkage; wherein

the first steering engine is mounted on the fixing block, one end of the first steering disc is connected to the first steering engine, the other end of the first steering disc is connected to one end of the first linkage, the other end of the first linkage is provided with a first ball, the first ball is ball-connected to the mirror cover; and

the first steering engine is configured to drive the first steering disc to swing and drive the first linkage to be hoisted, such that one end, connected to the first ball, of the mirror assembly is rotatable about one of the at least one first axis of rotation.

Optionally, the adjustment device further includes a second adjustment unit, the second adjustment unit including a second steering engine, a second steering disc, and a second linkage; wherein

the second steering engine is mounted on the fixing block, one end of the second steering disc is connected to the second steering engine, the other end of the second steering disc is connected to one end of the second linkage, the other end of the second linkage is provided with a second ball, the second ball is ball-connected to the mirror cover; and

the second steering engine is configured to drive the second steering disc to swing and drive the second linkage to be hoisted, such that one end, connected to the second ball, of the mirror assembly is rotatable about another of the at least one first axis of rotation.

Optionally, two first axes of rotation are perpendicular to each other, and the mirror balance assembly and the mirror assembly are connected at an intersection of the two first axes of rotation.

Optionally, the first ball and the second ball are both mounted at an edge of the mirror cover.

Optionally, the adjustment device includes a first adjustment unit, the first adjustment unit including a motor, a motor gear, and a transmission gear; wherein

the motor is fixed to the support frame, the motor gear is connected to the motor, the motor gear is in mesh with the transmission gear, and the transmission gear is fixedly connected to the fixing block; and

the motor is configured to drive the motor gear to rotate to drive the transmission gear to rotate, such that the fixing block is rotatable about a second axis of rotation relative to the support base, the second axis of rotation being parallel to the projection light beam emitted by the projection unit.

Optionally, the adjustment device includes a second adjustment unit, the second adjustment unit including a steering, a steering disc, a linkage, and a suspension hole support; wherein

the steering is fixed to the fixing block, and the steering disc is connected to the steering;

one end of the linkage is connected to the steering disc, the other end of the linkage is provided with the suspension hole support, the suspension hole support is fixed to the mirror cover, and the mirror assembly is rotatable about the suspension hole support relative to the linkage; and

the steering is configured to output a rotation force to drive the steering disc to rotate to drive the linkage to be hoisted, such that the mirror assembly is driven to rotate about one of the at least one first axis of rotation.

Optionally, the mirror balance assembly includes a linkage, a gimbaled ball, and a gimbaled ball groove; wherein

one end of the linkage is fixed to the fixing block, and the other end of the linkage is provided with the gimbaled ball;

the gimbaled ball groove is fixed to the mirror assembly, the gimbaled ball is mounted in the gimbaled ball groove, and the gimbaled ball is positioned at a center of gravity of the mirror assembly; and

the mirror assembly is rotatable about the gimbaled ball towards any direction relative to the linkage.

As compared with the related art, the mirror assembly according to the embodiments of the present disclosure is suspended on the support frame, the mirror assembly is rotatable about at least one first axis of rotation relative to the support frame, and the adjustment device is configured to cause the mirror assembly to be inclined along the at least one first axis of rotation relative to the mirror balance assembly. In this way, the mirror assembly is flexibly adjusted at a plurality of angles, and thus a projection light source is reflected to a projection region by the mirror with a greater range.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic perspective view of a projection apparatus according to one embodiment of the present disclosure;

FIG. 2 is a schematic perspective view of a projection apparatus according to another embodiment of the present disclosure; and

FIG. 3 is a schematic perspective view, taken from another angle, of a projection apparatus according to another embodiment of the present disclosure.

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical,” “horizontal,” “left,” “right,” “inner,” “outer,” and similar expressions are only for illustration purposes.

Unless the context clearly requires otherwise, throughout the specification and the claims, technical and scientific terms used herein denote the meaning as commonly understood by a person skilled in the art. Additionally, the terms used in the specification of the present disclosure are merely for describing the objectives of the specific embodiments, and are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

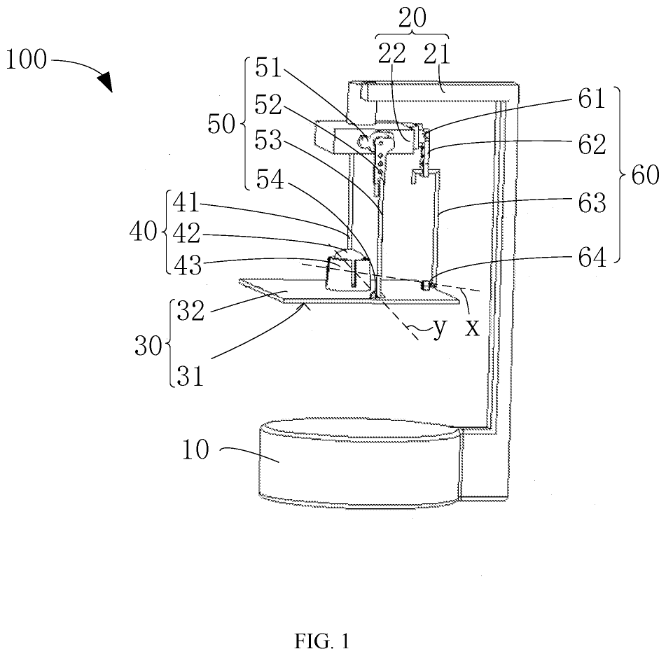

Referring to FIG. 1, FIG. 1 is a schematic structural view of a projection apparatus 100 according to an embodiment of the present disclosure. As illustrated in FIG. 1, the projection apparatus 100 includes: a projection unit 10, a support frame 20, a mirror assembly 30, a mirror balance assembly 40, and an adjustment device. One end of the support frame 20 is fixed to the projection unit 10, and the other end of the support frame 20 is suspended. The mirror assembly 30 is suspended over the projection unit 10. One end of the mirror balance assembly 40 is fixed to the other end of the support frame 20 that is suspended, and the other end of the mirror balance assembly 40 is connected to the mirror assembly 30. The adjustment device is connected to the support frame 20 and the mirror assembly 30, and is configured to adjust a position of the mirror assembly 30.

The projection unit 10 is provided with a lens (not illustrated). The lens faces towards the mirror assembly 30, and is configured to emit a projection light beam. The support frame 20 includes a support base 21 and a fixing block 22. One end of the support base 21 is fixed to the projection unit 10, and the other end of the support base 21 is suspended. The end of the support base 21 that is suspended is connected to the fixing block 22. The mirror balance assembly 40 suspends the mirror assembly 30 on the fixing block 22. The adjustment device is mounted on the fixing block 22.

The mirror assembly 30 includes a mirror 31 and a mirror cover 32. The mirror 31 is nested on one side of the mirror cover 32, and the other side, facing away from the mirror 31, of the mirror cover 32 is connected to the mirror balance assembly 40. The mirror 31 faces towards the projection unit 10. The projection light beam emitted by the lens is reflected by the mirror 31. It may be understood that a shape of the mirror 31 may be designed according to the actual needs, which may be, for example, a circle, a rectangle, an ellipse, or the like; and a shape of the mirror cover 32 is adaptive to the shape of the mirror 31.

The mirror balance assembly 40 includes a linkage 41, a gimbaled ball 42, and a gimbaled ball groove 43. One end of the linkage 41 is fixed to the fixing block 22, and the other end of the linkage 41 is fixed to the gimbaled ball 42. The gimbaled ball groove 43 is disposed on the side, facing away from the mirror 31, of the mirror cover 32. The gimbaled ball 42 is mounted in the gimbaled ball groove 43. The gimbaled ball 42 is rollable towards any directions in the gimbaled ball groove 43. In this way, the mirror assembly 30 is rotatable towards any directions about at least one first axis of rotation relative to the fixing block 22. The at least one first axis of rotation includes a first axis x and a second axis y. The first axis x is perpendicular to the second axis y, and the first axis x and the second axis y are intersected at a center of the gimbaled ball 42. Each of the first axis x and the second axis y is arranged to form an included angle with the projection light beam emitted by the projection unit. That is, neither the first axis x nor the second axis y is parallel to the projection light beam emitted by the projection unit. Preferably, the gimbaled ball 42 is disposed at a center of gravity of the mirror assembly 30, such that the mirror assembly 30 may keep balance.

The adjustment device includes a first adjustment unit 50 and a second adjustment unit 60. The first adjustment unit 50 and the second adjustment unit 60 are both connected to the fixing block 22 and the mirror assembly 30, and are both configured to adjust the position of the mirror assembly 30.

The first adjustment unit 50 includes a first steering engine 51, a first steering disc 52, and a first linkage 53. The first steering engine 51 is fixed to the fixing block 22 and the first steering disc 52 is connected to the first steering engine 51. The first steering engine 51 is configured to supply a rotation power to drive the first steering disc 52 to rotate. An axis of rotation of the first steering engine 51 is in coincidence with an axis of rotation of the first steering disc 52. One end of the first linkage 53 is connected to the first steering disc 52, and the other end of the first linkage 53 is provided with a first ball 54. A center of the first ball 54 is on the second axis y. The first ball 54 is ball-connected to the side, facing away from the mirror 31, of the mirror cover 32, such that the mirror cover 32 is rotatable about the first ball 54 towards any directions relative to the first linkage 53. The first steering engine 51 drives the first steering disc 52 to rotate to drive the first linkage 53 to be hoisted, such that one end of the mirror assembly 30 connected to the first ball 54 is inclinable about the first axis x. The mirror assembly 30 is connected to the first linkage 53 by the first ball 51, such that multi-angle rotation is implemented and the mirror 31 is smoothly steered.

Similarly, the second adjustment unit 60 includes a second steering engine 61, a second steering disc 62, and a second linkage 63. The second steering engine 61 is fixed to the fixing block 22 and the second steering disc 62 is connected to the second steering engine 61. The second steering engine 61 is configured to supply a rotation power to drive the second steering disc 62 to rotate. An axis of rotation of the second steering engine 61 is in coincidence with an axis of rotation of the second steering disc 62. One end of the second linkage 63 is connected to the second steering disc 62, and the other end of the second linkage 63 is provided with a second ball 64. A center of the second ball 64 is on the first axis x. The second ball 64 is ball-connected to the side, facing away from the mirror 31, of the mirror cover 32, such that the mirror cover 32 is rotatable about the second ball 64 towards any directions relative to the second linkage 63. The second steering engine 61 drives the second steering disc 62 to rotate to drive the second linkage 63 to be hoisted, such that one end of the mirror assembly 30 connected to the second ball 64 is inclinable about the second axis y. The mirror assembly 30 is connected to the second linkage 63 by the second ball 61, such that multi-angle rotation is implemented and the mirror 31 is smoothly steered.

It may be understood that in some other embodiments, either the first adjustment unit 50 or the second adjustment 60 may be omitted, and the numbers of first adjustment units 50 and second adjustment units 60 may be increased according to the actual needs. For example, two first adjustment units 50 and two second adjustment units 60 are arranged, as long as angle adjustment may be implemented for the mirror assembly 30.

The first ball 54 and the second ball 64 are both positioned at an edge of the mirror cover 32. The first axis x and the second axis y are respectively positioned within two central axial faces of the mirror cover 32. That is, the first ball 54 is positioned at an intersection of the second axis y and the edge of the mirror cover 32, and the second ball 64 is positioned at an intersection between the first axis x and the mirror cover 32. The gimbaled ball 42, the first ball 54, and the second ball 64 are arranged at a right-angled triangle, and the position of the mirror assembly 30 is determined based on three vertexes of the triangle. The gimbaled ball 42 is fixed relative to a position of the fixing block 22, and the first ball 54 and the second ball 64 are respectively adjustable in terms of height and distance relative to the fixing block 22, such that an inclination degree of the mirror assembly 30 relative to the fixing block 22 is adjustable and the mirror assembly 30 is securely connected to the fixing block 22.

In this embodiment, the mirror balance assembly 40 is configured to suspend the mirror assembly 30 to the fixing block 22, the mirror assembly 30 is rotatable relative to the support base 21, the first adjustment unit 50 and the second adjustment unit 60 are both capable of driving the mirror assembly 30 to be inclined relative to the fixing block 22, thereby implementing flexible steering at multiple angles of the mirror assembly 30.

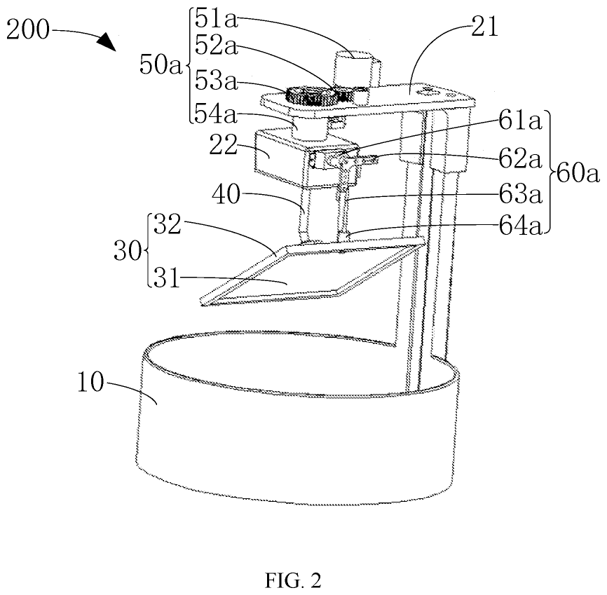

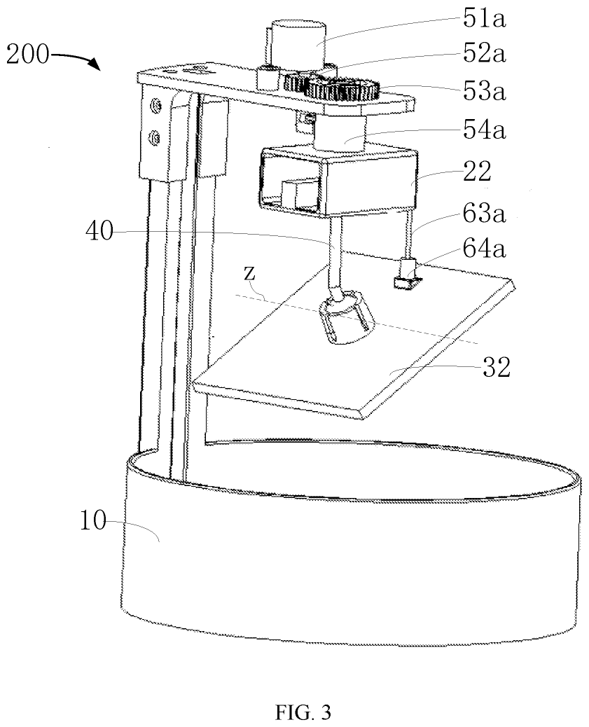

Referring to FIG. 2 and FIG. 3, schematic structural views of a projection apparatus 200 according to another embodiment of the present disclosure are illustrated. As illustrated in FIG. 2 and FIG. 3, different from the projection apparatus 100 in the above embodiment, the adjustment device includes a first adjustment unit 50a and a second adjustment unit 60a. The first adjustment unit 50a is mounted on the support base 21, and the second adjustment unit 60a is connected to the fixing block 22 and the mirror assembly 30.

The first adjustment unit 50a includes a motor 51a, a motor gear 52a, a transmission gear 53a, and a transmission shaft 54a. The motor 51a is fixed to the suspended end of the support base 21, and the motor 51a includes an output shaft. The output shaft is configured to output a rotation force. The motor gear 52a is connected to the output shaft of the motor 51a, and an axis of rotation of the motor gear 52a is in coincidence with an axis of rotation of the output shaft. The motor gear 52a and the transmission gear 53a are both disposed on the support base 21, the motor gear 52a is in mesh with the transmission gear 53a, and the axis of rotation of the motor gear 52a is parallel to an axis of rotation of the transmission gear 53a. The transmission gear 53a is connected to one end of the transmission shaft 54a, the axis of rotation of the transmission gear 53a is in coincidence with an axis of rotation of the transmission shaft 54a, and the other end of the transmission shaft 54a is connected to the fixing block 22. The motor 51a outputs a rotation force to drive the motor gear 52a to drive the transmission gear 53a to rotate, and then drive the fixing block 22 to rotate by the transmission shaft 54a, such that the mirror assembly 30 connected to the fixing block 22 is driven to rotate about a central axis of the transmission shaft 54a.

The second adjustment unit 60a includes a steering 61a, a steering disc 62a, a linkage 63a, and a suspension hole support 64a. The steering 61a is fixed to the fixing block 22, one end of the steering disc 62a is connected to the steering 61a, the steering 61a outputs a rotation force to drive the steering disc 62a to rotate. The other end of the steering disc 62a is connected to one end of the linkage 63a, the suspension hole support 64a is fixed to one side of the mirror cover 31 facing upward, and the suspension hole support 64a is connected to the other end of the linkage 63a, such that the mirror assembly 30 is rotatable about the suspension hole support 64a relative to the linkage 63a. The steering 61a drives the steering disc 62a to rotate to drive the linkage 63a to move upwards and downwards, such that the mirror assembly 30 is inclinable about a horizontal axis z relative to the support base 21.

It may be understood that in some other embodiments, the first adjustment unit 50a may be omitted, and the number of second adjustment units 60 may be increased according to the actual needs. For example, two second adjustment units 60 are arranged, as long as angle adjustment may be implemented for the mirror assembly 30.

It should be noted that in this embodiment, the horizontal axis z defines, together with the projection light beam emitted by the projection unit 10, an included angle, and serves as the first axis of rotation; and the central axis of the transmission shaft 54a is parallel to the projection light beam emitted by the projection unit 10, and serves as the second axis of rotation. The first axis of rotation is perpendicular to the second axis of rotation. The mirror assembly 30 is rotatable about the first axis of rotation and the second axis of rotation respectively, such that an angle of the mirror assembly 30 relative to the projection unit 10 is adjusted.

In this embodiment, the mirror balance assembly 40 is configured to suspend the mirror assembly 30 to the fixing block 22, the mirror assembly 30 is rotatable relative to the fixing block 22, the first adjustment unit 50a is capable of driving the fixing block 22 to rotate to drive the mirror assembly 30 rotate relative to the support base 21, and the second adjustment unit 60 is capable of driving the mirror assembly 30 to be inclined relative to the fixing block 22, thereby implementing flexible steering at multiple angles and within a great range of the mirror assembly 30.

It may be understood that in some embodiments, the first adjustment unit 50a in the second embodiment may be applicable to the first embodiment, such that the mirror assembly 30 is rotatable about the first axis x, the second axis y, and the central axis of the transmission shaft 54a respectively relative to the support base 21, thereby implementing full-angle adjustment.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection apparatus, comprising:
a projection unit, configured to emit a projection light beam;
a mirror assembly, suspended and configured to reflect the projection light beam emitted by the projection unit;
a support frame, one end of which is mounted on the projection unit;
a mirror balance assembly, configured to suspend the mirror assembly on the support frame, the mirror assembly being rotatable about at least one first axis of rotation relative to the support frame, the at least one first axis of rotation being disposed to define an included angle with the projection light beam emitted by the projection unit; and
an adjustment device, configured to drive the mirror assembly to rotate about the at least one first axis of rotation relative to the mirror balance assembly.

2. The projection apparatus according to claim 1, wherein the support frame comprises a support base and a fixing block, one end of the support base being fixed to the projection unit, and the other end of the support base being provided with the fixing block; and
the mirror balance assembly is configured to suspend the mirror assembly on the fixing block, and the adjustment device is mounted on the fixing block.

3. The projection apparatus according to claim 2, wherein the mirror assembly comprises a mirror and a mirror cover; wherein
the mirror is disposed on one side of the mirror cover, and the other side, facing away from the mirror, of the mirror cover is connected to the mirror balance assembly; and
the mirror is configured to reflect the projection light beam emitted by the projection unit.

4. The projection apparatus according to claim 3, wherein the adjustment device comprises a first adjustment unit, the first adjustment unit comprising a first steering engine, a first steering disc, and a first linkage; wherein
the first steering engine is mounted on the fixing block, one end of the first steering disc is connected to the first steering engine, the other end of the first steering disc is connected to one end of the first linkage, the other end of the first linkage is provided with a first ball, the first ball is ball-connected to the mirror cover; and
the first steering engine is configured to drive the first steering disc to swing and drive the first linkage to be hoisted, such that one end, connected to the first ball, of the mirror assembly is rotatable about one of the at least one first axis of rotation.

5. The projection apparatus according to claim 4, wherein the adjustment device further comprises a second adjustment unit, the second adjustment unit comprising a second steering engine, a second steering disc, and a second linkage; wherein
the second steering engine is mounted on the fixing block, one end of the second steering disc is connected to the second steering engine, the other end of the second steering disc is connected to one end of the second linkage, the other end of the second linkage is provided with a second ball, the second ball is ball-connected to the mirror cover; and
the second steering engine is configured to drive the second steering disc to swing and drive the second linkage to be hoisted, such that one end, connected to the second ball, of the mirror assembly is rotatable about another of the at least one first axis of rotation.

6. The projection apparatus according to claim 5, wherein two first axes of rotation are perpendicular to each other, and the mirror balance assembly and the mirror assembly are connected at an intersection of the two first axes of rotation.

7. The projection apparatus according to claim 6, wherein the first ball and the second ball are both mounted at an edge of the mirror cover.

8. The projection apparatus according to claim 2, wherein the adjustment device comprises a first adjustment unit, the first adjustment unit comprising a motor, a motor gear, and a transmission gear; wherein
the motor is fixed to the support frame, the motor gear is connected to the motor, the motor gear is in mesh with the transmission gear, and the transmission gear is fixedly connected to the fixing block; and
the motor is configured to drive the motor gear to rotate to drive the transmission gear to rotate, such that the fixing block is rotatable about a second axis of rotation relative to the support base, the second axis of rotation being parallel to the projection light beam emitted by the projection unit.

9. The projection apparatus according to claim 8, wherein the adjustment device further comprises a second adjustment unit, the second adjustment unit comprising a steering, a steering disc, a linkage, and a suspension hole support; wherein
the steering is fixed to the fixing block, and the steering disc is connected to the steering;
one end of the linkage is connected to the steering disc, the other end of the linkage is provided with the suspension hole support, the suspension hole support is fixed to the mirror cover, and the mirror assembly is rotatable about the suspension hole support relative to the linkage; and
the steering is configured to output a rotation force to drive the steering disc to rotate to drive the linkage to be hoisted, such that the mirror assembly is driven to rotate about one of the at least one first axis of rotation.

10. The projection apparatus according to claim 2, wherein the mirror balance assembly comprises a linkage, a gimbaled ball, and a gimbaled ball groove; wherein
one end of the linkage is fixed to the fixing block, and the other end of the linkage is provided with the gimbaled ball;
the gimbaled ball groove is fixed to the mirror assembly, the gimbaled ball is mounted in the gimbaled ball groove, and the gimbaled ball is positioned at a center of gravity of the mirror assembly; and
the mirror assembly is rotatable about the gimbaled ball towards any direction relative to the linkage.
